(19) United States
(12) Patent Application Publication
(10) Pub. No.: US 2003/0004784 A1
(43) Pub. Date: Jan. 2, 2003

(54) Methods and apparatus for automatic replenishment of inventory using embedded sensor system and electronic marketplace

(75) Inventors: Chung-Sheng Li, Ossining, NY (US); Mahmoud Naghshineh, Hopewell Junction, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 09/896,584

(22) Filed: Jun. 29, 2001

(51) Int. Cl. G06F 17/60

(52) U.S. Cl. 705/10

(57) ABSTRACT

Techniques are provided for automatically replenishing inventory by exploiting the use of electronic marketplaces. In one aspect of the invention, a system for automatically controlling an inventory of items comprises one or more sensors operative to automatically obtain information relating to a status associated with an inventory item. Preferably, the sensors are embedded in the equipment containing the inventory that they are monitoring. The system also comprises one or more computer systems (referred to herein as “brokers”) which are operatively coupled to the one or more sensors and which receive the status information from the one or more sensors. Each broker is further operative to automatically access one or more electronic marketplaces in order to determine one or more optimal parameters, based on the collected status information, to be used for replenishing an inventory item in accordance with one or more providers of the item via the one or more electronic marketplaces. The system further may comprise one or more other computer systems (referred to herein as “gateways”) which are operatively coupled between the one or more sensors and the one or more broker computer systems.

### CROSS REFERENCE TO RELATED APPLICATIONS

This patent application is related to the U.S. patent application identified by attorney docket no. YOR920010406US1, entitled “Methods and Apparatus for Enabling an Electronic Information Marketplace,” filed concurrently herewith.

### FIELD OF THE INVENTION

The present invention relates to techniques for automatically replenishing inventory and, more particularly, to automatic inventory replenishment techniques which employ remote sensors for collecting information through gateways, and brokers for aggregating and deaggregating the collected information and for leveraging conditions associated with an electronic marketplace.

### BACKGROUND OF THE INVENTION

Inventory control, whether associated with a home, an office, a retail store, a warehouse, etc., is known to be a cumbersome and time consuming task, particularly when performed manually and when the size of the inventory is large or particularly volatile (i.e., large turnover).

Automatic replenishment of inventory has been discussed in the home environment, such as mechanisms for attempting to replenish grocery items when the inventory in the home is low. However, such automated mechanisms for replenishing inventory do not employ automated purchasing mechanisms which take into account important market conditions associated with the item. Such market conditions may have an impact on the optimum time to purchase an item, as well as on the optimum quantity of the item to purchase.

Further, there have been proposals regarding the generation of automatic alerts when equipment runs out of (or is about to run out of) some item required to operate. However, these proposals have also not been considered in the context of the purchasing mechanisms and market conditions mentioned above.

Most of the conventional systems generate alerts and/or order requests when the inventory reaches a pre-established threshold. This threshold is usually set based on a consideration of the time it takes to replenish the inventory. However, none of these conventional systems consider and/or take advantage of the purchasing mechanisms and market conditions mentioned above.

Prior work is also known to have occurred in accordance with the development of supply chain optimization techniques in which an optimal replenishing schedule is generated for raw materials or office supplies. This is often referred to as “just-in-time replenishing.” However, this is not always the best model for replenishing inventory, nor does it consider and/or take advantage of the purchasing mechanisms and market conditions mentioned above.

U.S. Pat. No. 5,765,143 issued to Sheldon et al. on Jun. 9, 1998 discloses a computer system for controlling inventory of vendors at one level of a parts distribution chain. The system discloses a forecast method used to control parts inventory that utilizes reference data which considers the number of sales of a vendor in its market area during a particular time period. However, the system does not employ automated purchasing mechanisms which take into account market conditions which may have an impact on the optimum time to purchase an item, as well as on the optimum quantity of the item to purchase. Thus, the system does not have any automated mechanisms for leveraging the market conditions to place orders.

U.S. Pat. No. 5,168,445 issued to Kawashima et al. on Dec. 1, 1992 discloses an automated ordering system in a retail shop adapted to automatically order goods. However, again, the system does not employ automated mechanisms which take into account the above-mentioned market conditions.

### SUMMARY OF THE INVENTION

The present invention provides techniques for automatically replenishing inventory which exploit the use of electronic marketplaces. As is known with respect to the World Wide Web (or the Internet), “electronic marketplaces” (also referred to as “e-marketplaces”) are web sites comprising one or more server systems which allow visitors, via their own computers, to openly offer items for sale, place bids on items, trade items, and permit the use of various pricing mechanisms to discover the true “value” of a certain item based on the equilibrium of supply and demand. Examples of such electronic marketplaces or trading networks that have emerged and are commercially available include WebSphere Commerce Suite Marketplace Edition (trademark of IBM Corporation), Ariba Buyer and Ariba Marketplace (trademarks of Ariba, Inc.), Market Set (trademark of SAPMarkets, Inc.), and ConnectTrade (trademark of Metiom, Inc.). As will be illustratively explained below, the present invention utilizes such electronic marketplaces in order to provide end consumers with automated inventory control. However, it is to be understood that the invention is not limited to any particular electronic marketplace.

In one aspect of the invention, a system for automatically controlling an inventory of items comprises one or more sensors operative to automatically obtain information relating to a status associated with an inventory item. Preferably, the sensors are embedded in the equipment containing the inventory that they are monitoring. The system also comprises one or more computer systems (referred to herein as “brokers”) which are operatively coupled to the one or more sensors and which receive the status information from the one or more sensors. Each broker is further operative to automatically access one or more electronic marketplaces in order to determine one or more optimal parameters, based on the collected status information, to be used for replenishing an inventory item in accordance with one or more providers of the item via the one or more electronic marketplaces. The system further may comprise one or more other computer systems (referred to herein as “gateways”) which are operatively coupled between the one or more sensors and the one or more broker computer systems.

Each broker may also monitor pricing and/or supply trends associated with the electronic marketplaces on a particular inventory item. Further, the one or more optimal parameters determined by the broker may comprise an optimal time to acquire an inventory item via the electronic marketplaces, as well as an optimal quantity of the inventory item to acquire. Each broker may also aggregate and/or deaggregate the collected information in order to determine the one or more optimal parameters. Further, each broker may automatically place an order for an item in an electronic marketplace and/or automatically generate an alert to an individual that an order may need to be placed for an item. Still further, each broker may automatically collect usage pattern information associated with an item, as well as gather information on a market condition associated with the item.

In another aspect of the invention, each broker may automatically generate a recommendation for a different brand and/or a different type of an item to a consumer of the inventory.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1A is a block diagram illustrating an automatic inventory replenishment system according to an embodiment of the present invention;

FIG. 1B is a block diagram illustrating a generalized hardware architecture of a system suitable for implementing an embedded sensor of the present invention;

FIG. 1C is a block diagram illustrating a generalized hardware architecture of a computer system suitable for implementing various components of the present invention;

FIG. 2 is a block diagram illustrating an automatic inventory replenishment system according to a buy-side private marketplace embodiment of the present invention;

FIG. 3 is a block diagram illustrating an automatic inventory replenishment system according to a sell-side private marketplace embodiment of the present invention;

FIG. 4 is a flow diagram illustrating a process of leveraging inventory and market conditions to determine the optimal timing and quantity for replenishing inventory according to an embodiment of the present invention;

FIG. 5 is a flow diagram illustrating a process of automatic generation of recommendations for new brands/types of merchandise in an automatic inventory replenishment system according to an embodiment of the present invention; and

FIG. 6 is a flow diagram illustrating a process that an embedded system, hosted brokers, and an electronic marketplace are independently optimizing with respect to their individual objectives while reaching an equilibrium, in accordance with the present invention.

### DETAILED DESCRIPTION OF THE PREFERRED EMBODIMENT

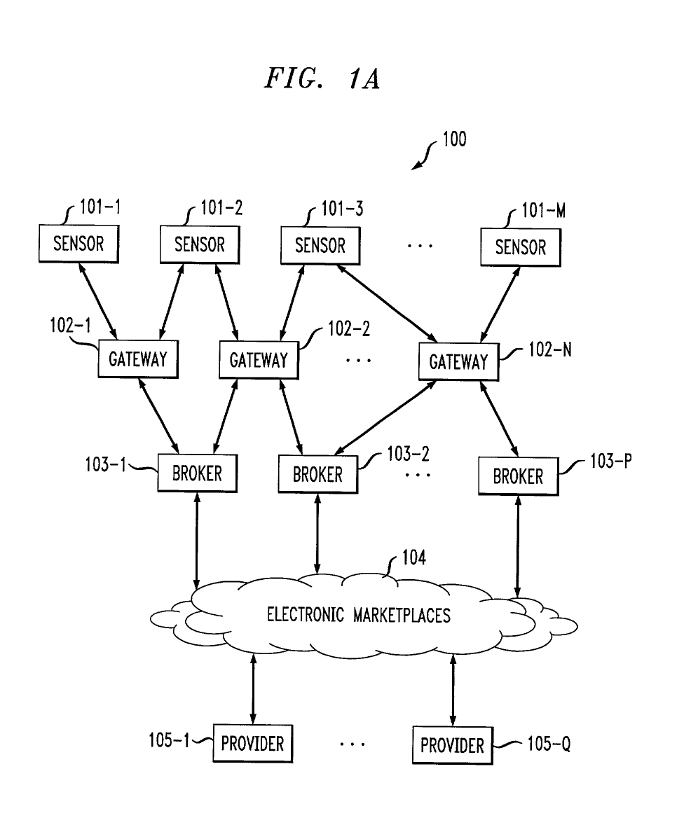

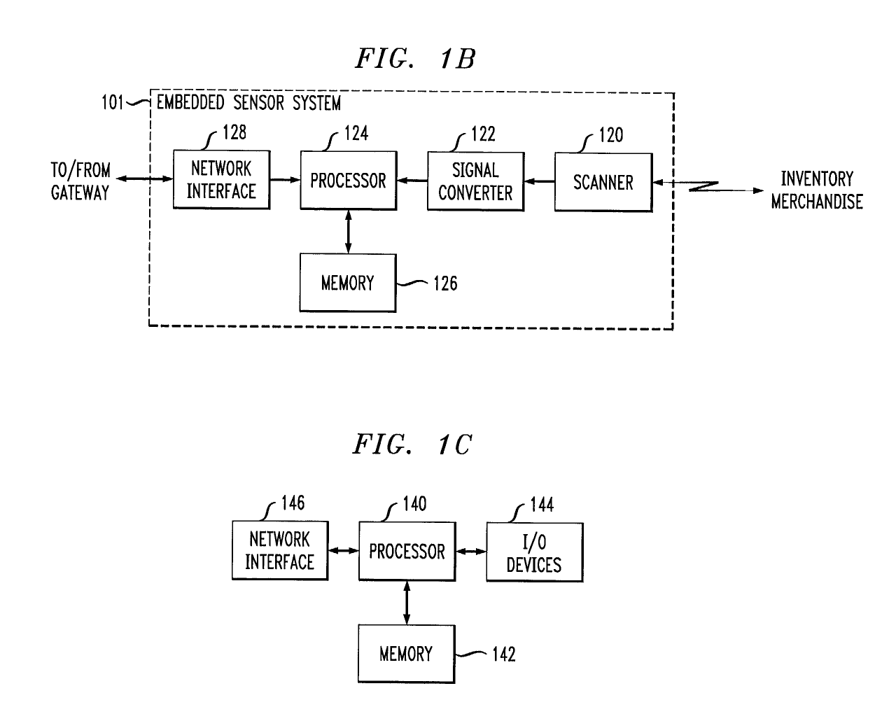

Referring initially to FIG. 1A, a block diagram illustrates an automatic inventory replenishment system according to an embodiment of the present invention. As shown in FIG. 1A, an automatic inventory replenishment system 100 comprises sensors 101-1 through 101-M, gateways 102-1 through 102-N, brokers 103-1 through 103-P, electronic marketplaces 104, and providers 105-1 through 105-Q. It is to be understood that the variables M, N, P and Q may represent any number of devices, wherein M, N, P and Q do not have to be the same number and are, most likely, not the same number. In general, FIG. 1A depicts an overall illustrative structure of sensors 101 connected through gateways 102 and brokers 103 to electronic marketplaces 104 for buying from (and trading with) providers 105 who are also connected to the electronic marketplaces.

It is to be understood that the present invention may be employed in conjunction with any type of electronic marketplace such as, for example, the commercially available electronic marketplaces and trading networks mentioned above. In addition, the invention may be employed with the electronic information marketplace disclosed in the U.S. patent application identified by attorney docket no. YOR920010406US1, entitled “Methods and Apparatus for Enabling an Electronic Information Marketplace,” filed concurrently herewith, and incorporated by reference herein.

It is to be understood that the particular application or applications that system 100 can be deployed in are not critical to the invention. By way of example only, the system 100 may be deployed in an inventory control application relating to a home, an office, a retail store, a warehouse, or all of the above environments. The particular application dictates the type of sensors 101 that are deployed in the system 100.

Thus, by way of example only, the sensors 101-1 through 101-M can be in one or more of the following forms:

(1) Sensors deployable in an embedded environment such as: (i) sensors embedded in an automobile for sensing the temperature, speed, pressure, etc., of the automobile such that components (e.g., tires, belts, etc.) that are affected by such conditions (e.g., become worn due to such conditions) and that may need to be ordered can be monitored; (ii) sensors embedded in home appliances such as those in a refrigerator, microwave oven, air conditioner, home safety alarm system, boiler, etc., such that components in these systems that may need to be ordered can be monitored; (iii) sensors embedded in computer peripherals such as a printer, a fax machine, a copy machine, etc., such that components in these systems that may need to be ordered can be monitored;

(2) Sensors for acquiring audio, images, and video through known audio-video surveillance mechanisms which can be used to detect the presence, type, and quantity of objects, e.g., inventory items;

(3) Radio frequency (RF) sensors for scanning tags as may typically be attached to merchandise for declaring the content of (or a description of) the merchandise when illuminated with a microwave source.

Referring now to FIG. 1B, a generalized hardware architecture is shown of a system suitable for implementing an embedded sensor of the present invention. The embedded sensor system 101 may comprise a scanner 120, a signal converter 122, a processor 124, memory 126, and a network interface 128. Depending on the application, the scanner may be, for example, an optical bar code scanner, an RF tag scanner, or any other type of suitable scanner. The scanner monitors, either actively or passively, the condition or status of the merchandise of the inventory to be controlled (e.g., reading bar codes, tags, etc.). By way of example only, the sensor may be embedded in a home appliance (e.g., refrigerator, microwave oven, home entertainment system, etc.), shelves in a retail store, shelves in a warehouse, office supply shelves in offices, supplies tray in office machines (e.g., fax, printer, copier, etc.), such that the appliance or shelves are able to provide real-time status of the current inventory therein or thereon. It is to be appreciated that one skilled in the art will realize many other applications and environments wherein such smart sensors may be embedded, as well as other suitable, application-specific, automated monitoring methods for tracking the status of the inventory.

The scanner output is provided to a signal converter 122. In the case where the scanner outputs an analog signal indicative of the inventory condition or status, the signal converter may be, for example, an analog-to-digital (A/D) converter. As is known, the analog signal is converted to a digital signal which, in accordance with the processor 124, is stored in memory 126. It is to be understood that the processor 124 and memory 126 may be the same processor and memory used by the appliance in which the sensor is embedded, or it may be a processor/memory arrangement dedicated to the sensor. The processor 124 then packages the sensory data and sends a data signal containing the sensory data, via the network interface 128, to a gateway 102 (FIG. 1A). The gateway serves as a repository for the captured data and may be located within the home, office, or any institution operatively coupled in the system 100.

As illustratively shown in FIG. 1A, various sensors 101 are coupled to various gateways 102. It is to be understood that the number and connectivity of the sensors and gateways is dependent on the particular application. For example, the sensors 101 and one or more of the gateways 102 may be operatively coupled through a wireless network, a home network, a wide area network, and/or a local area network. For example, the network may be a communication network based on Bluetooth, HomeRF, 802.11, CDPD (Cellular Digital Packet Data), GPRS (General Packet Radio Service), P1394, and Ethernet. As is known, 802.11 is the IEEE standard for wireless local area networks. P1394, also known as Firewire, is a high speed network protocol for transmitting digital video (many new digital video camcorders have a P1394 interface). Each gateway 102 receives the inventory information collected from its associated sensors 101. Thus, in the case of a home networking application, the sensors may be located throughout the home to monitor the inventory condition or status of various equipment or systems in the home. The sensors then transmit the information to one or more gateways in the home (or outside the home) via the communications network coupling the sensors and the gateways.

Referring now to FIG. 1C, a block diagram illustrates a generalized hardware architecture of a computer system suitable for implementing a gateway. The gateway may comprise a processor 140, memory 142, I/O devices 144, and a network interface 146. It is to be appreciated that the term “processor” as used herein is intended to include any processing device, such as, for example, one that includes a CPU (central processing unit) and/or other processing circuitry. The processor may also include a digital signal processor, as is well known in the art. The term “memory” as used herein is intended to include memory associated with a processor or CPU, such as, for example, RAM, ROM, a fixed memory device (e.g., hard drive), a removable memory device (e.g., diskette), flash memory, etc. In addition, the term “input/output devices” or “I/O devices” as used herein is intended to include, for example, one or more input devices (e.g., keyboard, mouse, etc.) for entering data to the processing unit, and/or one or more output devices (e.g., CRT display, printer, etc.) for presenting results associated with the processing unit. It is also to be understood that the term “processor” may refer to more than one processing device and that various elements associated with a processing device may be shared by other processing devices.

Accordingly, software components including instructions or code for performing the methodologies of the invention, as described herein, may be stored (e.g., as an article of manufacture) in one or more of the associated memory devices (e.g., ROM, fixed or removable memory) and, when ready to be utilized, loaded in part or in whole (e.g., into RAM) and executed by a CPU.

The gateway 102 communicates with its associated sensors via its network interface 146, in accordance with the particular communication protocol employed between the devices. Once the information is collected by the gateways, the information can then be sent to brokers 103. In one scenario, the information can be the current condition of the inventory level of the device or system that the sensor is embedded in. In another scenario, the information can be a request for replenishment.

It is to be appreciated that FIG. 1C may also be considered to illustrate a generalized hardware architecture of a computer system suitable for implementing a broker. The broker computer system is responsible for aggregating or deaggregating the orders potentially received from multiple gateways, and placing the order in the electronic marketplaces 104, so that the providers 105 of the goods can respond to those orders. Thus, the broker receiving data from a plurality of clients and aggregating the data can then procure an item for a plurality of clients simultaneously thereby realizing the cost benefits of volume purchasing. On the other hand, by deaggregating the data, the broker may be able to take advantages of purchasing opportunities on smaller quantities. The broker is also responsible for monitoring the pricing and supply trends of the major electronic marketplaces on a set of items. The broker also calculates the optimal entry point for replenishing supplies.

Each broker may also gather information to be used in making its optimal buy decisions. One type of data that the broker gathers is usage patterns of particular items. This data may be accumulated through the smart sensors 101 and gateways 102. In one embodiment, the usage patterns are expressed as a time series. Another type of data that the broker gathers is the market condition of the item. This data is gathered from the interoperable electronic marketplaces and may represent the market conditions in terms of supply and pricing, the result of which can also be expressed as a number of time series. For example, supply and pricing data may be the recent transaction record and inventory of an item, expressed as a time series (e.g., a time series of price and time series of quantity in stock).

Each broker may also store and execute rules for sending alerts or ordering when the inventory becomes low (e.g., below a certain threshold), or when market condition reach new lows and there is sufficient room to house inventory.

Further, with the information a broker gathers from the sensors (e.g., past usage trends, demand parameters, etc.) and from the electronic marketplaces (e.g., availability, pricing, supply parameters, etc.), the broker can automatically generate recommendations to the end consumer relating to new types and/or brands of merchandise. These recommendations may be presented to the end consumer, for example, at one or more of the gateways 102.

As illustratively shown in FIG. 1A, various gateways 102 are coupled to various brokers 103. It is to be understood that the number and connectivity of the gateways and brokers is dependent on the particular application. For example, the gateways and one or more of the brokers may be operatively coupled through a wireless network, a wide area network, and/or a local area network, such as are mentioned above. In one embodiment, the gateways may be operatively coupled to the brokers via the Internet.

The brokers 103 visit various electronic marketplaces 104, each of which are comprised of one or more servers which allow the brokers to openly place bids on items in an environment that employs a pricing mechanism that allows potential buyers (brokers 103) and sellers (providers 105) to discover the true “value” of a certain item based on the equilibrium of supply and demand.

It is to be appreciated that FIG. 1C may also be considered to respectively illustrate a generalized hardware architecture of a computer system suitable for implementing a provider and/or an electronic marketplace site.

In a preferred embodiment, the computer systems utilized by the gateways, the brokers, the electronic marketplaces, and the providers are preferably operatively coupled via the Internet, while the sensors and gateways are preferably operatively coupled by more of a local network (e.g., local area network, Bluetooth, etc.) and located within the homes and/or businesses of the end consumers (e.g., the persons or entities whose inventories are being automatically controlled).

With such an automated inventory replenishing system, several advantages are realized, some examples of which are:

(i) Continuous supply—in accordance with the principles of the invention, the inventory will rarely reach zero for an extended period of time (the tolerance for zero supply is individual, family, or institution-dependent).

(ii) Nearly minimal “running” cost—by taking advantage of the pricing and supply information from interoperable electronic marketplaces, minimal expenditure is achieved for the continuous operation;

(iii) Automated recommendations—by dynamically exploring for and suggesting new brands/selections based on the previous usage (e.g., a different type of brand of the same cereal, or a different type of cereal from the same brand);

(iv) Machine-to-machine—nearly zero human intervention, that is, in one embodiment, the sensors, gateways, brokers, electronic marketplaces, and providers may provide fully automatic inventory replenishing. However, it is to be understood that individuals may be involved with decision aspects of the process at the sensors, gateways, brokers, electronic marketplaces, and/or providers of the system 100.

As a result, the objective is to optimize the average cost function (over a period of time) subject to constraints of nearly continuous supply. That is, in order to maintain continuous supply, an order has to be placed before supply runs out. As a result, determining the optimal order placement time according to the invention allows the automated system to take advantage of the prediction of the market condition during the interval prior to running out of supply and to place the order at the time when the price of the item is predicted to be minimal during the interval.

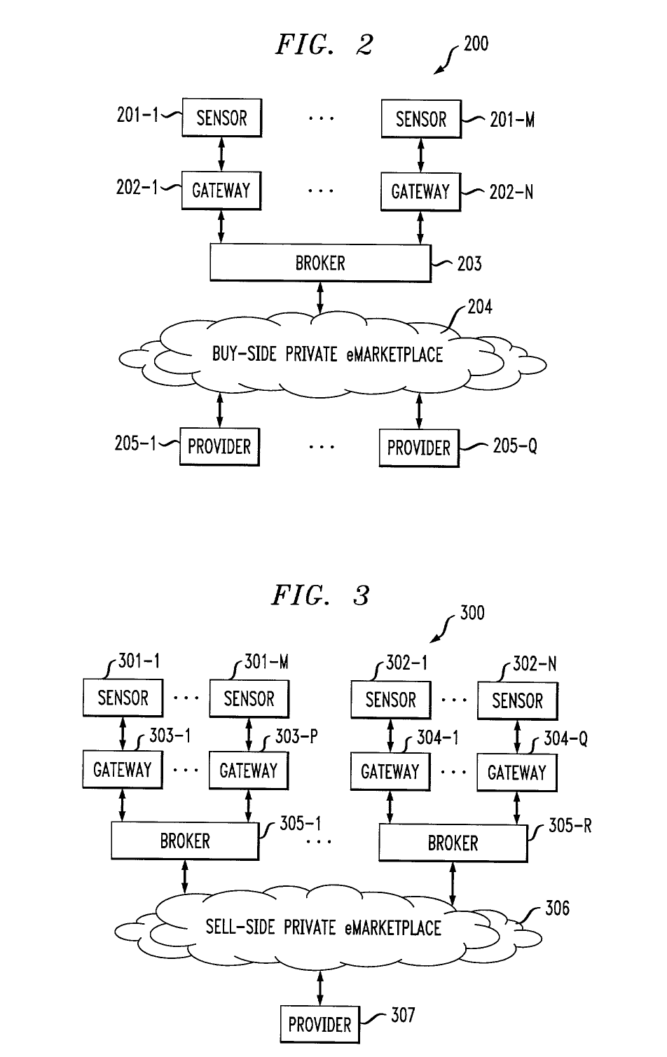

Referring now to FIG. 2, a block diagram illustrates an automatic inventory replenishment system according to a buy-side private marketplace embodiment of the present invention. Specifically, FIG. 2 illustrates a system structure 200 for going through a buy-side private electronic marketplace to place an order. It is to be understood that the components in the system 200 have the same or similar functions as the same or similarly named components shown in FIG. 1, unless otherwise specified below.

A buy-side private electronic marketplace implies a marketplace with a single buyer and multiple providers. Similar to FIG. 1A, the information collected by the sensors 201-1 through 201-M is sent to the broker 203 via the gateways 202-1 through 202-N. The broker 203 may aggregate orders from multiple gateways, and place the order based on a model which invites competitive bids from the providers 205-1 through 205-Q via a private electronic marketplace 204.

This embodiment situation may apply to the case when a broker is a dominant company in its field, such as the regional Bell company (e.g., Verizon, SBC), AOL/Time Warner, or ADT home security system. For example, AOL/Time Warner is a dominant Internet service provider, ADT is a dominant home security system provider, and the regional Bell companies are dominant local phone service providers. All of these providers have large customer bases and wiring in place to wire all of the homes of its customers. As a result, this guarantees the size of the market and generates incentives for the providers to participate in the system 200.

Referring now to FIG. 3, a block diagram illustrates an automatic inventory replenishment system according to a sell-side private marketplace embodiment of the present invention. Specifically, FIG. 3 shows a system structure 300 of a sell-side private electronic marketplace. It is to be understood that the components in the system 300 have the same or similar functions as the same or similarly named components shown in FIG. 1, unless otherwise specified below.

A sell-side private electronic marketplace implies a private marketplace of a single seller and multiple buyers. Similar to FIG. 1, multiple brokers 305-1 through 305-R collect information (e.g., inventory levels, orders) from the sensors 301-1 through 301-M and 302-1 through 302-N via the gateways 303-1 through 303-P and 304-1 through 304-Q, respectively. These brokers place the orders to the same provider 307 through the marketplace 306 set up by the provider. This embodiment may apply to the case where an electronic marketplace is set up for major providers of parts and merchandise, such as the toners for Hewlett Packard printers, Xerox/Kodak copiers, etc.

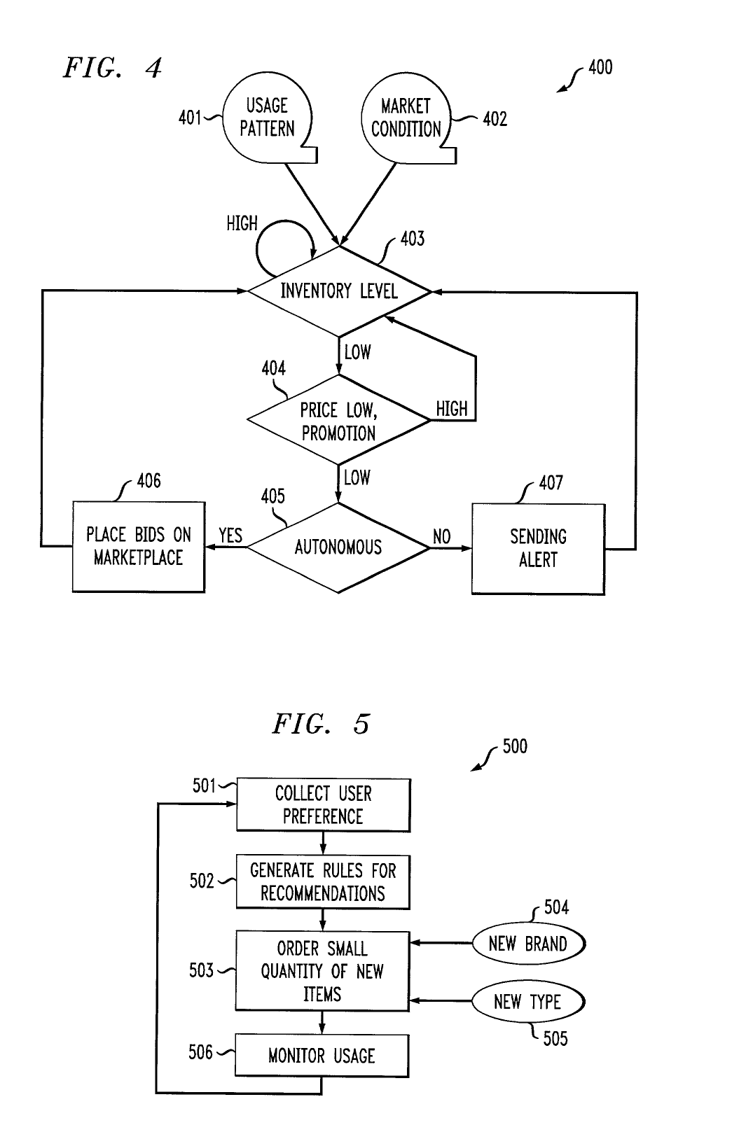

Referring now to FIG. 4, a flow diagram illustrates a process of leveraging inventory and market conditions to determine the optimal timing and quantity for replenishing inventory according to an embodiment of the present invention. Specifically, FIG. 4 illustrates a process 400 for setting up ordering in accordance with smart sensors through an electronic marketplace at the broker computer system. In this case, a sensor collects instantaneous information such as the inventory level or the current condition of the device/equipment in which the sensor is embedded, and provides the information to a broker via a gateway. The information, which can be used to generate the usage pattern, becomes a time series 401. The market condition is also monitored by the broker and collected into a time series 402. Known models to characterize and predict the usage pattern and market conditions are employed at the broker. Examples of models that can be used to predict the market condition include simple linear models (or linear regression models), linear predictive models where the coefficients are adjusted adaptively based on previous inputs, neural network models, etc.

If the inventory level is less than full (or high), as determined at step 403, the market condition is checked in step 404 to determine whether any action shall be taken. For example, the broker may learn from the electronic marketplace that a provider is having a sales promotion or that the price of a subject item at this time is particularly low. Again, these operations at the broker may be done automatically by the computer system of the broker or with human assistance (e.g., an individual operating the broker computer system). If the inventory is full (or high), the process iterates. If an autonomous mode 405 is ON at the broker (e.g., fully automated operation mode), an order is placed in step 406 when the condition is appropriate. It is to be understood that the condition here is referring to a market condition, e.g., a sale/promotion event, when the market price dips, or when the market price is predicted to reach a minimum when replenishment of the inventory is needed, etc. When the autonomous mode 405 is OFF at the broker (e.g., operator assistance or proxy assistance operation mode), an alert is sent in step 407 to a proxy or a person who can take action. Note that an objective of the end client is to maintain continuous supply with minimal running cost. As a result, the models for the usage and the market fluctuation may be exploited so that optimal order placement timing and quantities are realized.

Also, it is to be understood that the provider of the subject item, once an order is placed via the electronic marketplace, may deliver the item(s) to the end consumer whose inventory is being monitored via traditional delivery techniques (e.g., mail) or electronically via the system, if the item is in electronic form.

FIG. 4 provides inventory replenishment as if in a supply chain environment. However, innovation and change is common in a consumer-centric environment, i.e., consumers usually try different brands of consumer products, or different types of consumer products from the same brand name. Accordingly, FIG. 5 is a flow diagram illustrating a process 500 of automatic generation of recommendations for new brands/types of merchandise in an automatic inventory replenishment system according to an embodiment of the present invention. Specifically, FIG. 5 illustrates an automatic methodology for introducing new items in such an automatic replenishment environment. It is to be appreciated that, in one embodiment, the recommendations may be made by a broker to an end consumer via a gateway.

First, user preference is collected in step 501 either explicitly (e.g., such as through specification of a user profile stored at a broker) or implicitly (e.g., such as through mining usage behavior from the sensors as mentioned above). In step 502, a set of recommendation rules relating to new brands 504 and/or items 505 are then generated based on these explicitly or implicitly generated rules. This recommendation generation step may be similar to collaborative filtering processes, such as those that are known to be used for promotion, upsale, and cross-sale. A small quantity of the recommended merchandise is then ordered in step 503. The usage pattern of these newly ordered items is then monitored, in step 506, and the monitoring results used to revise the user profile.

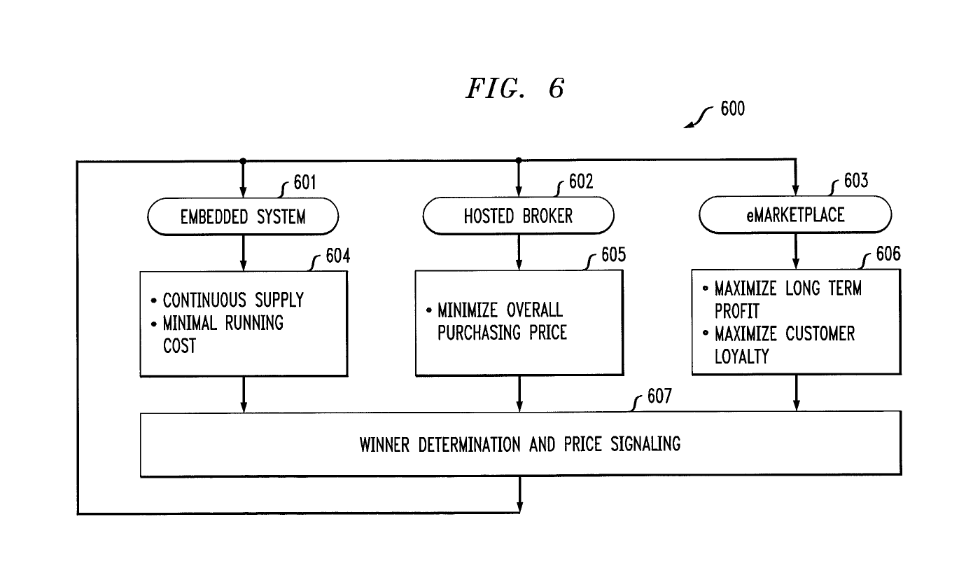

Referring now to FIG. 6, a flow diagram illustrates a process 600 that an embedded system, hosted brokers, and an electronic marketplace, operating in accordance with the present invention, are independently optimizing with respect to their individual objectives while reaching an equilibrium. It is to be understood that the components in the process 600 have the same or similar functions as the same or similarly named components shown in FIG. 1, unless otherwise specified below. More specifically, FIG. 6 illustrates the distributed nature of optimization objectives that are sought to be respectively realized in accordance with the embedded sensor systems 601, the hosted brokers 602, and the electronic marketplace 603.

The embedded sensor systems attempt to maintain continuous supply while maintaining minimal running cost (objectives 604). The hosted brokers try to minimize the overall purchasing price (objective 605) either through aggregation (and thus leveraging the volume discount when available), or deaggregation (to leverage different price demand curves from the providers). The electronic marketplace performs the matchmaking process among the consumers and providers of the goods and tries to maximize the long term profit (or welfare) of the entire community comprising the providers and consumers of the goods, while also attempting to maximize consumer loyalty (objectives 606).

Although these entities have their own objectives, they interact through the electronic marketplace using the regular market mechanism (e.g., fixed-price, dynamic pricing) with a common winner determination and price signaling process 607. For example, for various trading mechanisms in the marketplace, such as auctions, reverse auctions, request for quotes (RFQs), each mechanism always involves a winner determination step where the best bid (in the case of an auction or a reverse auction) is determined and then the price of the bid is calculated based on the rules of the auction/reverse auction. This is an example what process 607 may involve.

By way of another illustrative example of the invention, this time in the context of an automobile application, the automated system of the invention may have one or more sensors located in the automobile. Whenever any part in the automobile reaches its end of life, the automated system seeks out the part from a parts provider with the best price or on sale, and seeks out a dealer with the lowest price to replace the part. Advantageously, the date of the repair (to replace the part) may be arranged before the anticipated end of life of the part, but the automated system leverages the potential volatility of the market (both the parts and labor) and seeks the best time to do the repair.

Advantageously, as has been explained in detail above, the replenishing system of the invention may operate with no need for the human intervention, i.e., the entire process of trading can be entirely autonomous (machine to machine or “M2M”).

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A computer-based method of automatically controlling an inventory of items, the method comprising the steps of:
automatically collecting information relating to a status associated with at least one inventory item; and
automatically accessing at least one electronic marketplace in order to determine one or more optimal parameters, based on the collected status information, to be used for replenishing the at least one inventory item via the at least one electronic marketplace.

2. The method of claim 1, wherein the electronic marketplace accessing step further comprises monitoring at least one of pricing and supply trends associated with the at least one electronic marketplace on the at least one inventory item.

3. The method of claim 1, wherein the one or more optimal parameters comprise an optimal time to acquire the at least one inventory item via the at least one electronic marketplace.

4. The method of claim 1, wherein the one or more optimal parameters comprise an optimal quantity of the at least one inventory item to acquire via the at least one electronic marketplace.

5. The method of claim 1, further comprising the stop of one of aggregating and deaggregating the collected information in order to determine the one or more optimal parameters.

6. The method of claim 1, further comprising the step of automatically placing an order for the at least one item on the at least one electronic marketplace.

7. The method of claim 1, further comprising the step of automatically generating an alert to an individual that an order may need to be placed for the at least one item.

8. The method of claim 1, wherein the step of automatically collecting information further comprises collecting usage pattern information associated with the at least one item.

9. The method of claim 1, wherein the step of accessing the at least one electronic marketplace further comprises gathering information on a market condition associated with the at least one inventory item.

10. The method of claim 1, further comprising the step of automatically generating a recommendation of at least one of a different brand and a different type of an item to a consumer of the inventory.

11. A computer-based method of performing machine-to-machine inventory control, the method comprising the steps of:
receiving, in accordance with a first machine, a data signal generated by a sensor system indicative of a status of an inventory of items being monitored by the sensor system; and
procuring, in accordance with a second machine via at least one electronic marketplace, additional such items for an end consumer based on the data signal and depending on one or more optimal market conditions associated with the items.

12. The method of claim 11, wherein the data signal generated by the sensor system is passed through from the sensor system to the first machine via at least a third machine serving as a gateway.

13. The method of claim 11, wherein the sensor system is embedded.

14. The method of claim 11, wherein the data signal further comprises information about a history of inventory of such items.

15. Apparatus for automatically controlling an inventory of items, the apparatus comprising:
at least one processor operative to: (i) receive automatically collected information relating to a status associated with at least one inventory item; and (ii) automatically access at least one electronic marketplace in order to determine one or more optimal parameters, based on the collected status information, to be used for replenishing the at least one inventory item via the at least one electronic marketplace; and
memory, coupled to the at least one processor, for storing at least the collected status information.

16. The apparatus of claim 15, wherein the electronic marketplace accessing operation further comprises monitoring at least one of pricing and supply trends associated with the at least one electronic marketplace on the at least one inventory item.

17. The apparatus of claim 15, wherein the one or more optimal parameters comprise an optimal time to acquire the at least one inventory item via the at least one electronic marketplace.

18. The apparatus of claim 15, wherein the one or more optimal parameters comprise an optimal quantity of the at least one inventory item to acquire via the at least one electronic marketplace.

19. The apparatus of claim 15, wherein the at least one processor is further operative to one of aggregate and deaggregate the collected information in order to determine the one or more optimal parameters.

20. The apparatus of claim 15, wherein the at least one processor is further operative to automatically place an order for the at least one item on the at least one electronic marketplace.

21. The apparatus of claim 15, wherein the at least one processor is further operative to automatically generate an alert to an individual that an order may need to be placed for the at least one item.

22. The apparatus of claim 15, wherein the at least one processor is further operative to automatically collect usage pattern information associated with the at least one item.

23. The apparatus of claim 15, wherein the at least one processor is further operative to gather information on a market condition associated with the at least one inventory item.

24. The apparatus of claim 15, wherein the at least one processor is further operative to automatically generate a recommendation of at least one of a different brand and a different type of an item to a consumer of the inventory.

25. A system for automatically controlling an inventory of items, the system comprising:
at least one sensor operative to automatically obtain information relating to a status associated with at least one inventory item; and
at least one computer system, operatively coupled to the at least one sensor, operative to receive the status information and to automatically access at least one electronic marketplace in order to determine one or more optimal parameters, based on the collected status information, to be used for replenishing the at least one inventory item in accordance with at least one provider of the item via the at least one electronic marketplace.

26. The system of claim 25, further comprising at least another computer system, operatively coupled between the at least one sensor and the first computer system, operative to serve as a gateway.
